(19) United States
(12) Patent Application Publication
(10) Pub. No.: US 2008/0167904 A1
(43) Pub. Date: Jul. 10, 2008

(54) Premium financed life insurance products and methods

(76) Inventors: David Rudich, Los Angeles, CA (US); William E. Gray, Los Angeles, CA (US)

Correspondence Address: DANIEL B. SCHEIN, PH.D., ESQ., INC., P. O. BOX 68128, Virginia Beach, VA, 23471, US

(21) Appl. No.: 11/906,993

(22) Filed: Oct. 4, 2007

Related U.S. Application Data
(60) Provisional application No. 60/849,271, filed on Oct. 4, 2006.

(51) Int. Cl. G06Q 40/00

(52) U.S. Cl. 705/4

(57) ABSTRACT

Premium financed insurance products and methods which can eliminate the requirement for excess collateral beyond the policy itself are disclosed, wherein the premiums for an insurance policy covering the life of an insured are paid by a loan, and wherein the loan agreement, the policy and/or related documents include a provision or are accompanied by an agreement for pooling of the death benefit of the policy with the death benefit amounts derived from other premium financed policies in the pool, wherein in the event of a cancellation event the loan for the cancelled policy is repaid with interest on a pro-rata basis from and out of the death benefits of other policies in the pool. In an embodiment, a second policy or rider to the first policy is subject to pooling, wherein the second policy offsets the risks associated with the lack of excess collateral previously required. A cancellation event may be caused by, among other things, a suicide or false statement, fraud or material concealment in obtaining the policy, a failure of an insurer or an increase in premium payment rates. In an embodiment, a right of first refusal to purchase the policy or the policy benefits from the insured may be granted to the lender. Also disclosed is a computer system for implementing the products and methods.

This application claims priority of U.S. Provisional Patent Application 60/849,271, filed Oct. 4, 2006.

### FIELD OF THE INVENTION

These inventions relate to products and methods for providing life insurance to an insured for whom premiums are financed by a third party, sometimes referred to as premium financed life insurance. More particularly, the inventions relate to products and methods and a computer system for providing premium financed life insurance that reduces or eliminates collateral requirements of the insured.

### BACKGROUND OF THE INVENTION

A prospective insured may find that using after-tax dollars to purchase life insurance makes little sense after considering the costs of the premium(s), gift taxes to get the insurance out of the individual's estate (so it's not taxed as part of his or her estate) and the loss of the time value of the money used to pay the premiums. The foregoing factors can change the economics of an insurance purchase so severely that one commonly puts more money into the policy than one's beneficiaries receive back-often well before one's life expectancy has been reached.

A solution to this dilemma is premium financed life insurance. Specifically, life insurance can be offered on a zero net outlay basis, including, in some cases, offering of policies permitting the death benefit to grow on a guaranteed minimum basis to cover the financing costs. A number of carriers have created such products. Such policies meet the needs of clients for life insurance that address estate taxes, fund legacies for children, and/or provide for charitable bequests.

An example of how one can fund insurance policies via third parties is disclosed in U.S. Pat. No. 6,950,805 to Bart Kavanaugh, wherein life insurance policies are funded using annuities that are purchased at least in part using borrowed money, and business and trust structures can be used to reduce and/or eliminate tax. This investing can be done either directly by the policy or through the trust and/or other business entity. As an internal investment of the insurance policy, the income generated by the annuity and the inside build-up are non-income taxable to the owner of the policy. The resulting death benefits will also be nonincome taxable to the beneficiary.

It is possible for a person to obtain third party financing for a premium financed life insurance policy under circumstances where the life insurance policy serves as partial collateral for the loan. The loan can be repaid from the proceeds of the insurance policy at death. In another embodiment, after a predetermined period of time, the party financing the loan and/or a third party can purchase the policy or policy benefits from the insured.

Trusts are often established to facilitate these transactions and minimize the tax obligations, and ideally eliminate tax liabilities completely. The trusts can borrow money to pay the premiums for life insurance policies. Sophisticated transactions can permit interest to accrue on the loan and the interest to be paid to the lender along with the loan principal at the time of the death of the insured from the death benefit.

However, there generally exists a gap between the collateral value of the policy and the collateral required for the premium loan, so that valuable assets usually must be posted as collateral in addition to the policy, also referred to herein as “excess collateral.” This excess collateral can be required to cover loan repayment risks such as, for example, suicide prior to a date set forth by the policy when the risk of suicide will no longer be an excluded peril (generally two years), death before a deadline (also generally two years) after which the insurance company can no longer contest a purchaser's representation or failure to disclose a material fact in the process of applying for and acquiring the policy or the risk of cancellation of the insurance policy or denial of the death benefit for any other reason, wherein such an event is also referred to herein as a “cancellation event.” This excess collateral requirement can be a disincentive to individuals to acquire life insurance. Therefore, there is a need to minimize and preferably eliminate this excess collateral requirement.

### SUMMARY OF THE INVENTION

An embodiment of the present inventions overcomes the need for excess collateral on premium financed life insurance policies by providing a premium financed insurance product and an agreement for the pooling with other policies and policy holders of the risks to the lender of cancellation or nullification of the policy and a return of premiums or some other failure of the beneficiary to be paid the death benefit (i.e., a cancellation event risk pooling provision), whereby the death benefits of the pooled policies in effect serve as or substitute for the excess collateral for the premium financing. In an embodiment, where the insurance company refunds the policy premiums paid without interest after a cancellation event, the unrepaid interest amount (with interest thereon) would be paid to the lender from and out of the contractually created pool on a pro-rata basis as and when death benefits are realized from each of the pooled policies. Any interest and/or other monies remaining due on the loan for a policy after a cancellation event would be repaid to the lender with interest on such unpaid interest at the loan rate from the death benefits of the policies that are not canceled or denied as and when such death benefits are paid. The amount of the reduction in the death benefit for each policy holder could be pro rated based on the ratio of the amount of the death benefit of the policy to the total amount of the death benefit of all of the policies in the pool. This gives full protection to the lender while eliminating the need for any other excess collateral.

In a preferred embodiment, the cancellation events triggering contribution of payments from the death benefits of other policies in a pool of such policies would include, among other things, a suicide occurring within a predetermined period of time after issuance of the policy, and cancellation by an insurance carrier for false or fraudulent representations or concealment of one or more material facts within a predetermined period of time after issuance of the policy. In an embodiment, the cancellation event must occur within two years of issuance of the policy for the theretofore unpaid interest on the loan to be paid to the lender from and out of the death benefits of other policies in the pool.

The methods of pooling and providing of third party financed insurance policies in accordance with the present invention can be implemented by a computer system, wherein the system stores and as desired calculates data entries selected from the group consisting of the number and identity of the policies and policyholders in the pool during any particular time period, the death benefit amounts of each of the policies, the premium loan amounts for the respective policies, interest rates for each loan, accrued interest for each loan, value of each contributive share in the pool during any particular time period, the pro-rata share for each contributing policy with interest accruing on each share of the unpaid portion until payment of the contributing portion from the death benefit of such policy, the current life expectancy of each insured, and the full expected amount and date of repayment (with accrued interest) to and including the date of full repayment.

In an embodiment, the present inventions include a premium financed insurance product that includes a provision that gives the lender a right of first refusal to purchase the policy should the policy holder wish to sell it at a later date, also referred to herein as a “lender purchase rights” provision. In an embodiment, a premium financed life insurance product includes both a “cancellation event” risk pooling provision and a lender purchase rights provision, and the computer system mentioned previously also stores and as desired calculates policy benefit contribution shares.

In another embodiment, the policy holder would grant the lender the perpetual and irrevocable right to fund the premium financed loan by making premium payments directly to the insurance carrier. In a further embodiment, the policy holder would agree in the contract of insurance, the loan agreement or another document related to either of such agreements that the policy holder irrevocably and perpetually relinquishes any right that the policy holder may have to cancel, terminate or otherwise extinguish the life insurance policy or to cause the life insurance policy to be otherwise cancelled, terminated or otherwise extinguished.

Since bank loans are governed by regulations, such as those set by the Comptroller of the Currency under the US Department of the Treasury, it is desired to have greater flexibility than banks have in obtaining the financing for the present premium financing and insurance policy inventions. Thus, the present inventions provide for greater flexibility in securing hedge funds and other lenders that are not regulated in the same fashion as banks. In an embodiment, an insured would not have to post collateral beyond the policy and be able to sign non-recourse, rather than full recourse, promissory notes for financed insurance in accordance with the present inventions.

In another embodiment, a freshly established trust would borrow funds to pay for one or more life insurance policies with a Death Benefit growing by the amount of borrowed premiums and part or all of the cost of money, or interest rate. For example, as the insured's debt increases with respect to funds borrowed to obtain the subject insurance the amount of the insurance payout increases proportionately. This would have advantages, such as for example elimination of the use of after-tax money for premium payments, elimination of gift taxes to transfer funds to the trust (if a personal purchase, and/or the elimination of P.S. 58/Table 38 economic benefit costs (if a split dollar). Preferably, the trust is the sole or at least primary obligor on the loan debt and a pre-selected balance of the insurance proceeds after repayment of principal and interest on the debt is payable to the trust or for the trust to the lender.

In another embodiment, the trust would purchase a second life insurance policy, e.g. a universal life, or particularly, a guaranteed no-lapse universal life contract on the life of the insured. The second policy used in accordance with the present inventions could, for example, be designed and administered to, if need be, be drawn down to supplement or fund the return on equity, or agreed return, of the lender that financed a first policy. In the alternative, a first life insurance policy includes a rider, preferably non-commissionable, that escalates the death benefit to fund repayment of the loan and all or part of the accrued interest thereon to maintain a fixed death benefit.

In another embodiment, a pooling agreement is executed concurrently with or included in the insurance premium financing and/or purchase agreement to protect the lender from a series of eventualities or impracticalities (e.g., cancellation events) that would otherwise impact the lender's agreed return. For example, a pooling agreement in accordance with the present inventions allows for assessment of contracts in a pool of contracts, e.g., primary and/or secondary policies, either (1) via cash value withdrawals or (2) via entitlement to additional portions of the death benefit. Exemplary situations that could trigger such an assessment include but are not limited to:

(1) suicide within a specified time (e.g., two years) from the inception date of the policy or from a date agreed upon as the effective date of the policy (in an embodiment, suicide may result merely in a return of premiums causing the lender to be unsecured as to its interest for that period, and in another embodiment suicide, after a suicide peril exclusion period, if any, would result in return of premiums to the lender plus some or all accrued interest;

(2) fraud in the Application discovered within two (2) years the specified time within which the insurer may rescind the contract and return the premiums;

(3) failure of an insurer; and

(4) a change in the mortality or administrative expenses that causes more or larger premiums to be paid to keep the contracts in force until the death of the insured person; e.g., impracticalities that would otherwise impair the agreed return on the pool-wide combined loans of the lender.

In another embodiment, it is contemplated that the Pooling agreement would apply to one or more secondary life insurance policies, e.g., secondary Guaranteed Universal Life contracts, and not the first insurance policy. In that event, the insured would be assured that their beneficiary would receive the agreed upon base death benefit while the growth portion of the first and perhaps additional contract or contracts (growing by premiums paid and an interest rate) would go the lender at the death of the Insured. The lender's return would be protected or bolstered by the second policy, e.g., the Guaranteed Universal contract.

In another embodiment, contract #2 may be “split” from the outset so that its death benefit is divided 50/50 with the lender so that any early mortality events would accrue to the benefit of the lender and that would lessen the subsequent necessity of relying upon the death benefit pool established by the Pooling Agreements executed by the insureds in the pool.

### DESCRIPTION OF THE FIGURES

FIG. 1 illustrates the relationship of the various parties and cash flows, wherein the alphabetically labeled arrows are described in the FIGURE Key.

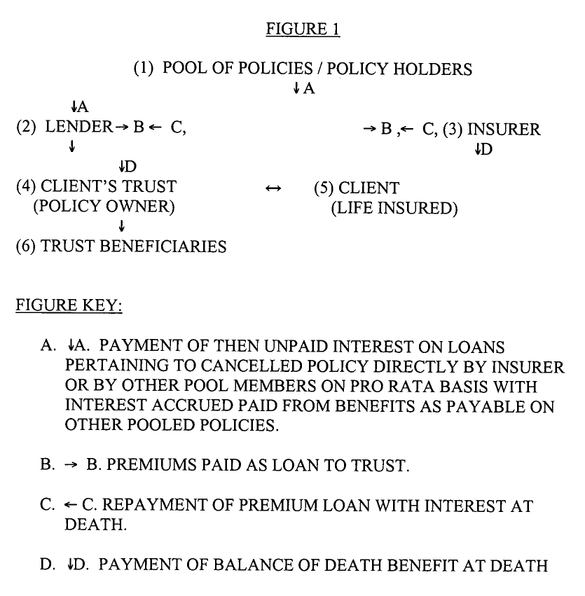

### FURTHER DESCRIPTION OF THE INVENTIONS

By use of the present inventions, a purchaser of a life insurance policy will not have to pay any money whatsoever out of his or her pocket and/or encumber assets other than the policy itself as collateral for a premium financed life insurance policy (or can have such a requirement minimized). This is facilitated in another embodiment by the simultaneous purchase of a second policy, for example, a universal life and/or whole life policy, wherein such policy is included in a pool of policies as described herein.

### Example 1

An insured agrees to settle a life insurance trust and empowers the trustee to borrow money from a lender and to use the borrowed funds to purchase two life insurance policies on the life of the insured with death benefits payable to the trust as follows:

Policy #1 is a $10,000,000 insurance contract with a premium of $500,000 annually with a Return of Premium Rider and an additional rider that causes the death benefit to grow in the amount of the premium loan, plus all or part of the accrued interest on the premium loan; at the end of the first year it is worth $10,500,000. Policy #2 is a $10,000,000 flat death benefit with a premium of $300,000. In the event of the Insured's death in Year #1, the Estate of the Insured receives $10 MM, the base amount of Policy #1. The lender receives $500,000 plus interest at an agreed rate from Policy #1, and the lender would also receive a portion of Policy #2, which could be (A) an amount sufficient to bring the lender's interest rate up to the policy loan interest rate and additionally to contribute on a pro rata basis with all other pool policies to bring the lender's pool-wide return up to a pre-agreed rate, or (B) the greater of (A) and 50% of the death benefit ($5,000,000). The (B) option above would provide the lender with additional incentive for the program and not cut into the portion in which the Insured is actually interested, i.e. the base $10 MM policy.

### Example 2

Terms of an exemplary agreement for carrying out the objectives set forth in Example 1 is set forth below:

THIS AGREEMENT is made this ______ day of ______, 2007 by and between ______ whose address is ______ (hereinafter “Lender”) and The ______ Irrevocable Life Insurance Trust, whose address is ______ (hereinafter “Trust”), and Life Plan Administrators, LLC, whose address is ______,

WHEREAS the Trust wishes to borrow from the Lender amounts to be furnished annually (hereinafter the “Loan”) sufficient for the Trust to purchase and pay annually for Premium Financed Life Insurance on the life of ______ (hereinafter the “Insured”), as set forth hereinafter;

WHEREAS the Trust wishes to purchase two or more life insurance policies on the life of the Insured (the “Policies”) which will, upon the death of the Insured, be sufficient in combined total death benefit amount to repay the loan including all interest thereon at the rate of ______ percent (______ %), compounded annually from the date of each premium payment until full and complete repayment (hereinafter the “Loan Interest Rate”) and pay the Insured's beneficiaries no less than the irreducible sum of $______ (hereinafter the “Irreducible Net Death Benefit Amount”) after the loan is repaid;

WHEREAS before and after the date of the agreement the Lender may have made and may hereafter make similar life insurance premium finance loans at various interest rates to other life insurance trusts and others for their purchase of similar life insurance policies on the lives of other insureds (hereinafter the “Other Life Insurance Policies”);

WHEREAS The Other Life Insurance Policies issued within the period commencing one year prior to the issuance of the first policy acquired by the Trust hereunder and ending one year after the issuance of the last policy acquired by the Trust hereunder, and the policies acquired by the Trust hereunder shall collectively be referred to herein as the “Pool Policies;”

WHEREAS the parties hereto wish to enter into this agreement to motivate and induce the Lender to make and continue to fund the Loan by providing fail safe protection to the Lender that the Loan and all other loans made by the Lender for the purchase, and maintenance of each of the Pool Policies will be repaid to the Lender in full with interest at the combined effective rate of ______ percent (______%) compounded annually (hereinafter the “Lender's Return”);

NOW AND THEREFORE, the parties agree as follows:

(1) Lender agrees to lend to the Trust by payment directly to the Insurers of sums equal to the premiums that will be required to be paid for the purchase and annual renewal (maintenance) of multiple policies on the life of the Insured to which this agreement pertains. One policy (hereinafter “Policy #1”) shall in the normal course be a life insurance policy the basic design of which follows the format created and patented by The Tax Track Companies, wherein the basic minimum “floor” death benefit of such policy contractually increases dynamically by the amount of the premiums paid to acquire and maintain such insurance policy and additionally by a fixed percent interest rate compounded annually (hereinafter the “Policy #1 Rate”). Upon the death of the Insured, the Irreducible Net Death Benefit Amount, shall be paid to the Trust, and the dynamically growing portion of the death benefit in the amount of the premiums paid and the interest that accrues at the Policy #1 Rate, compounded annually, (hereinafter the “Growth Portion”) shall be paid directly to the Lender, or if the Lender and the Trust so agree in writing, the Growth Portion of the death benefit shall also be paid by the insurance company to the Trust, in which case the Growth Portion of the death benefit shall be paid by the Trust to the Lender as soon as practicable, but no later than ten business days after the Trust's receipt thereof in partial satisfaction of the obligations of the Trust to the Lender for the borrowed funds.

(2) The other policy or policies (hereinafter the “Credit Enhancement Policy(ies)”) shall, unless the parties hereto otherwise agree in writing, be of a Guaranteed No-Lapse Universal Life design. Upon the death of the Insured, a sum shall be deducted from the death benefit of the Credit Enhancement Policy(ies) and paid to the Lender in an amount equal to the Lender's Return less the Growth Portion paid to the Lender in accordance with the provisions of Paragraph (1) hereinabove (hereinafter the “Supplemental Amount”).

(3) Additionally, upon the death of the Insured and at such time or times thereafter as the Lender may select at its discretion for a period of twelve (12) consecutive years commencing on the date of the death of the Insured (the Reallocation Period), the Lender shall calculate on a combined basis the effective interest rate that the Lender theretofore received (or will receive if any sum or sums that are due to the Lender have not yet been received) with respect to all loans made by the Lender for the acquisition of all Pool Policies on the lives of all insureds (including the Insured) who have theretofor died, and on all Pool Policies, if any, that have theretofor been cancelled or voided (hereinafter the “Finalized Policies”) taking into account all influencing factors such as, but not limited to any insurer insolvency, changes in any insurer's expenses within any Finalized Policy, any changes in mortality rates, suicide by any insured, fraud committed on or in connection with any application for any Finalized Policy, any other changes or unforeseen occurrences events or conditions that adversely affect the effective interest rate derived or to be derived by the Lender with respect to the Finalized Policies (hereinafter the “Finalized Policies Effective Interest Rate”). In the event that the Finalized Policies Effective Interest Rate, compounded annually, shall be less than ______ percent ( ), the Lender shall calculate the cash amount of such deficiency on a Finalized Policy wide basis (hereinafter the “Finalized Policy Interest Deficiency”). The Lender shall then multiply an amount equal to the Finalized Policy Interest Deficiency by a fraction the numerator of which shall be the sum of the death benefit amounts payable pursuant to all of the Credit Enhancement Policies acquired by the Trust hereunder and the denominator shall be the combined total of all of the death benefits of all of the Credit Enhancement Policies in the Pool. The resulting amount shall be referred to hereinafter as the “Finalized Policy Deficiency Share.” The Finalized Policy Deficiency Share shall be deducted and paid to the Lender from the remaining share of the death benefit from the Credit Enhancement Policy(ies) acquired by the Trust hereunder (after calculation and payment to the Lender of the Supplemental Amount in accordance with the provisions of Paragraph (2) hereof) and any Finalized Policy Deficiency shares previously calculated and paid to the Lender provided that in no event shall the amount so paid exceed the balance of the death benefit of the Credit Enhancement Policies acquired by the Trust hereunder.

(4) Upon the expiration of the Reallocation Period, the stipulated balance of the death benefit of the Credit Enhancement Policies acquired by the Trust hereunder that has not been paid to the Lender in accordance with the terms hereof, if any, shall be promptly paid to the Trust under the terms of the Program Administration Provisions of the Servicing Agreement with Life Plan Administrators, LLC. In no event shall the Trust's share of the death benefit of the Credit Enhancement Policy(ies) be less than zero, and in no event shall any of Irreducible Net Death Benefit of Policy #1, payable to the Trust pursuant to Paragraph (1) be allocated or paid to the Lender or shall the Trust be or remain indebted to the Lender after payment to the Lender of the Finalized Policy Deficiency share or shares of the Credit Enhancement Policy(ies) in accordance with the terms of this paragraph (3).

(5) The Insured agrees to promptly execute any and all changes of beneficiary, instructions to any Insurer and other documents that the Lender and/or Life Plan Administrators, may reasonably request to effectuate the terms of this agreement. In the event that Insured fails or refuses to do so, the Insured hereby irrevocably designates and appoints the Lender and/or Life Plan Administrators, LLC, as appropriate, as the Insured's Attorney-in-fact to execute any and all such documents in the Insured's stead provided that no such documents shall increase the Insured's liability or diminish any net death benefits payable to the Insured except only as expressly set forth herein.

Except as otherwise expressly set forth herein, and in any documents contemporaneously executed by and between the parties hereto, there are no oral, implied or other agreements between the parties hereto of any nature or kind. This agreement shall supersede any and all previous oral and written negotiations, commitments, agreements and understandings relating hereto. Any dispute between the parties shall be resolved by an action in a court of competent jurisdiction in (city) ______, (state) ______, as litigation shall be the chosen dispute resolution process.
This agreement is made and executed on this ______ day of in 2007, in the city of ______, in the county of ______, in the State of ______.

### TRUST

______ ______

### by: Trustee by: An Authorized Officer

### LIFE PLAN ADMINISTRATORS, LLC

### By: ______

An Authorized Member

The foregoing exemplary agreement would be signed by the parties or their authorized representatives.

### SUMMARY OF CERTAIN EMBODIMENTS

In view of the foregoing, non-limiting ways of summarizing embodiments of the present invention include:

(A) A premium financed life insurance product, comprising an insurance policy covering the life of an insured wherein the premiums are paid by a loan from at least one third party that creates a debt, wherein the loan agreement or policy includes a provision or is accompanied by a collateral agreement for pooling of a portion of the death benefit of said policy with portions of the death benefits of other premium financed life insurance policies in the same pooling group, wherein the payment of at least a portion of said debt is secured by portions of the death benefits of other policies in the pool in the event of a cancellation event.

In an embodiment of Product A the provider of a loan for the purchase of a policy does not require collateral in excess of the pledge of the policy that is purchased and execution of a pooling agreement by members of a pool who purchase such policies by means of loans to pay for the premiums. In another embodiment of Product A the cancellation event is based upon a suicide or a false or fraudulent representation or omission of a material fact within a predetermined time after issuance of said policy or perhaps the failure of an insurer or an increase in the insurance premium rates. For example, the suicide or fraudulent activity occurs within a predetermined time such as two years or a time set by a contract or statute.

(B) A computer system for implementing a premium financed insurance product, comprising a computer system for implementing a pool of life insurance policies wherein the premiums are paid by loans from at least one third party, wherein the loan agreements or policies include a provision for or are accompanied by an agreement for the pooling of all or a portion of the death benefits of each of said policies with other premium financed policies in the pool, wherein unpaid principal or interest on one or more of said loans as a result of one or more cancellation events is repaid on a pro-rata basis from the death benefits of other policies in the pool and wherein the loan for the payment of premiums paid to acquire and maintain said policy therefore does not require excess collateral.

(C) A premium financed insurance product, comprising an insurance policy covering the life of an insured wherein the premiums are paid by a loan from at least one third party, wherein the loan agreement or policy includes a provision or is accompanied by an agreement granting the lender a right of first refusal to purchase said policy or the benefits of said policy. An embodiment of product C further comprises a provision for pooling of the death benefit of said policy with other premium financed policies in the pool, wherein in the event of a cancellation event the unpaid amount due on said loan is paid out of a pool, and therefore wherein the loan to acquire and maintain said policy does not necessarily require excess collateral.

(D) A method of providing a premium-financed life insurance product which method comprises of:
(a) obtaining a person's assent to be insured under a life insurance policy of death benefit value X, requiring over the life of the insured person periodic life insurance premium payments as consideration for the maintenance of the policy until the time of the insured person's death;
(b) settling a trust comprising the steps of: (i) declaring the death benefit value X an asset of the trust; (ii) naming a trustee and (iii) naming one or more beneficiaries of the trust;
(c) obtaining the proposed insured person's assent to a premium financing agreement wherein the premium payments of the policy are paid by a third party lender in exchange for repayment to the lender after death of the insured, from trust assets (including the life insurance proceeds) of (i) paid premium payments, (ii) repayment of part or all of the agreed interest on the value of the paid premium payment amounts at an interest rate of I2;
(d) obtaining the person's assent to be insured under a second whole life insurance policy of death benefit value Y, requiring over the life of the insured person periodic life insurance other premium payments as consideration for the maintenance of the second policy until the time of the insured person's death;
(e) declaring the death benefit value Y (i) an asset of the trust, (ii) and payable to the lender as a trust creditor at the time of the insured person's death;
(f) obtaining the insured person's assent to a second premium financing agreement wherein the premium payments of the second policy are paid by the lender in exchange for repayment to the lender after death of the insured person, from trust assets (including the life insurance proceeds), an amount necessary to repay items (c)(i)-(c)(iii);
(g) obtaining the trust's contractual agreement upon settlement of the trust to pool pursuant to a pooling agreement the death benefit from one or more life insurance policies acquired by means of premium financing the death benefits with the death benefits of other members of the pool.

In embodiments of method D, the death benefit X or Y grows through time, or Y can be constant. In an embodiment of method D the death benefit X grows according to the amounts of the items in the group consisting of: (i) paid premium payments, and (ii) repayment of interest on the value of the paid premium amounts at an interest rate of I1. Embodiments of method D include the death benefit X being payable to a trust beneficiary other than the lender, the death benefit Y is payable in a priority claim order, for example, the death benefit Y is paid in the following order: lender, other beneficiary. In other embodiments of method D, the second policy is a universal life contract or a guaranteed no-lapse universal life contract. Method D may also include the pooling agreement requiring a trustee of the trust to compensate the lender or the another lender if a cancellation event occurs, which cancellation event is selected from the group consisting of, among other things: (a) a suicide of the insured person within two years after the issuance of a life insurance policy insuring the life of the insured person; (b) a suicide of the another insured person within two years after the issuance of a whole life insurance policy the life of the another insured person; (c) fraud in the application on the part of the insured person discovered within an applicable state statutory period after the making of the insurance policy; (d) fraud in the application on the part of the another insured person discovered within an applicable state statutory period after the making of the insurance policy; or (e) failure of an insurer.

In an embodiment of Method D, the pooling agreement requires a trustee of the trust to compensate the lender or the another lender if an impracticable condition is placed upon an insurer issuing a policy whose premiums are paid under a premium financing agreement as described in product A such that the lender or the another lender is required by an insurer to pay premium amounts greater than those originally contemplated by the first or second financing agreements or the other person's premium financing agreements. In another embodiment of Method D, the death benefit Y is split equally between the lender and another beneficiary.

Thus, exemplary embodiments and uses of the present inventions have been described. Alternative embodiments, descriptions and terms are contemplated. While exemplary embodiments of the present invention have been set forth above, it is to be understood that the pioneer inventions disclosed herein may be made and used otherwise than as specifically described.

1. A premium financed life insurance product, comprising an insurance policy covering the life of an insured wherein the premiums are paid by a loan from at least one third party that creates a debt, wherein the loan agreement or policy includes a provision or is accompanied by a collateral agreement for pooling of a portion of the death benefit of said policy with portions of the death benefits of other premium financed life insurance policies in the same pooling group, wherein the payment of at least a portion of said debt is secured by portions of the death benefits of other policies in the pool in the event of a cancellation event.

2. The product of claim 1, wherein the provider of a loan for the purchase of a policy does not require collateral in excess of the pledge of the policy that is purchased and execution of a pooling agreement by members of a pool who purchase such policies by means of loans to pay for the premiums.

3. The product of claim 1, wherein said cancellation event is based upon a suicide or a false or fraudulent representation or omission of a material fact within a predetermined time after issuance of said policy or perhaps the failure of an insurer or an increase in the insurance premium rates.

4. The product of claim 2, wherein said suicide or fraudulent activity occurs within a predetermined time such as two years or a time set by a contract or statute.

5. A computer system for implementing a premium financed insurance product, comprising a computer system for implementing a pool of life insurance policies wherein the premiums are paid by loans from at least one third party, wherein the loan agreements or policies include a provision for or are accompanied by an agreement for the pooling of all or a portion of the death benefits of each of said policies with other premium financed policies in the pool, wherein unpaid principal or interest on one or more of said loans as a result of one or more cancellation events is repaid on a pro-rata basis from the death benefits of other policies in the pool and wherein the loan for the payment of premiums paid to acquire and maintain said policy therefore does not require excess collateral.

6. A premium financed insurance product, comprising an insurance policy covering the life of an insured wherein the premiums are paid by a loan from at least one third party, wherein the loan agreement or policy includes a provision or is accompanied by an agreement granting the lender a right of first refusal to purchase said policy or the benefits of said policy.

7. The product of claim 5, further comprising a provision for pooling of the death benefit of said policy with other premium financed policies in the pool, wherein in the event of a cancellation event the unpaid amount due on said loan is paid out of a pool, and therefore wherein the loan to acquire and maintain said policy does not necessarily require excess collateral.

8. A method of providing a premium-financed life insurance product which method comprises of:
(a) obtaining a person's assent to be insured under a life insurance policy of death benefit value X, requiring over the life of the insured person periodic life insurance premium payments as consideration for the maintenance of the policy until the time of the insured person's death;
(b) settling a trust comprising the steps of: (i) declaring the death benefit value X an asset of the trust; (ii) naming a trustee and (iii) naming one or more beneficiaries of the trust;
(c) obtaining the proposed insured person's assent to a premium financing agreement wherein the premium payments of the policy are paid by a third party lender in exchange for repayment to the lender after death of the insured, from trust assets (including the life insurance proceeds) of (i) paid premium payments, (ii) repayment of part or all of the agreed interest on the value of the paid premium payment amounts at an interest rate of I2;
(d) obtaining the person's assent to be insured under a second whole life insurance policy of death benefit value Y, requiring over the life of the insured person periodic life insurance other premium payments as consideration for the maintenance of the second policy until the time of the insured person's death;
(e) declaring the death benefit value Y (i) an asset of the trust, (ii) and payable to the lender as a trust creditor at the time of the insured person's death;
(f) obtaining the insured person's assent to a second premium financing agreement wherein the premium payments of the second policy are paid by the lender in exchange for repayment to the lender after death of the insured person, from trust assets (including the life insurance proceeds), an amount necessary to repay items (c)(i)-(c)(iii);
(g) obtaining the trust's contractual agreement upon settlement of the trust to pool pursuant to a pooling agreement the death benefit from one or more life insurance policies acquired by means of premium financing the death benefits with the death benefits of other members of the pool.

9. The method according to claim 8 wherein the death benefit X grows through time.

10. The method according to claim 8 wherein the death benefit Y grows through time.

11. The method according to claim 8 wherein the death benefit Y is a constant.

12. The method according to claim 8 wherein the death benefit X grows according to the amounts of the items in the group consisting of: (i) paid premium payments, and (ii) repayment of interest on the value of the paid premium amounts at an interest rate of I1;

13. The method according to claim 8 wherein the death benefit X is payable to a trust beneficiary other than the lender.

14. The method according to claim 8 wherein the death benefit Y is paid in a priority claim order.

15. The method according to claim 14 wherein the death benefit Y is paid in the following order: lender, other beneficiary.

16. The method according to claim 8 wherein the second policy is a universal life contract.

17. The method according to claim 8 wherein the second policy is a guaranteed no-lapse universal life contract.

18. The method according to claim 8 wherein the pooling agreement requires a trustee of the trust to compensate the lender or the another lender if a cancellation event occurs, which cancellation event is selected from the group consisting of, among other things;
(a) a suicide of the insured person within two years after the issuance of a life insurance policy insuring the life of the insured person;
(b) a suicide of the another insured person within two years after the issuance of a whole life insurance policy the life of the another insured person;
(c) fraud in the application on the part of the insured person discovered within an applicable state statutory period after the making of the insurance policy;
(d) fraud in the application on the part of the another insured person discovered within an applicable state statutory period after the making of the insurance policy; or
(e) failure of an insurer.

19. The method according to claim 8 wherein the pooling agreement requires a trustee of the trust to compensate the lender or the another lender if an impracticable condition is placed upon an insurer issuing a policy whose premiums are paid under a premium financing agreement as described in claim 1 such that the lender or the another lender is required by an insurer to pay premium amounts greater than those originally contemplated by the first or second financing agreements or the other person's premium financing agreements.

20. The method according to claim 8 wherein the death benefit Y is split equally between the lender and another beneficiary.
